(19) United States
(12) Patent Application Publication
(10) Pub. No.: US 2014/0191837 A1
(43) Pub. Date: Jul. 10, 2014

(54) COIL ELEMENT AND METHOD FOR MANUFACTURING THE SAME

(71) Applicant: Samsung Electro-Mechanics Co., Ltd., Suwon-si (KR)

(72) Inventors: Byeong Cheol MOON, Suwon-si (KR); Soo Hwan SON, Suwon-si (KR); So Yeon SONG, Suwon-si (KR); Young IL LEE, Suwon-si (KR); Sung Eun KIM, Suwon-si (KR)

(73) Assignee: Samsung Electro-Mechanics Co., Ltd., Suwon-si (KR)

(21) Appl. No.: 14/146,464

(22) Filed: Jan. 2, 2014

(30) Foreign Application Priority Data
Jan. 4, 2013 (KR) 10-2013-0001091

(51) Int. Cl. H01F 5/00; H01F 41/04

(52) U.S. Cl. CPC H01F 5/003; H01F 41/041
USPC 336/200; 29/602.1

(57) ABSTRACT

The present invention relates to a coil element including a ceramic body and an internal electrode coil pattern formed on the ceramic body, wherein the ceramic body includes NiZnMn ferrite and the internal electrode coil pattern uses copper, and a method for manufacturing the same.

The NiZnMn ferrite in accordance with the present invention can greatly increase a sintering process window and implement characteristics of a material through a single sintering process by suppressing conductivity due to generation of deposits inside the NiZn ferrite material in a thin oxygen atmosphere through addition of Mn to the conventional NiZn ferrite composition to increase a resistivity of the material.

### CROSS-REFERENCE TO RELATED APPLICATIONS

Claim and incorporate by reference domestic priority application and foreign priority application as follows:
“CROSS REFERENCE TO RELATED APPLICATION

This application claims the benefit under 35 U.S.C. Section 119 of Korean Patent Application Serial No. 10-2013-0001091, entitled “Coil element and Method for manufacturing the same” filed Jan. 4, 2013, which is hereby incorporated by reference in its entirety into this application.”

### BACKGROUND OF THE INVENTION

1. Field of the Invention

The present invention relates to a coil element and a method for manufacturing the same.

2. Description of the Related Art

A multilayer chip inductor, a multilayer chip bead, and other module type products in which embedded coils are exposed use a NiCuZn ferrite material as a ceramic body material. Since a conductor resistance has a large influence on inductance characteristics of the products (quality factor Q, thermal characteristics), 100% silver (Ag) is used as an internal electrode.

Therefore, in order to sinter the NiCuZn ferrite material at a temperature of 960° C. or less, which is a melting point of silver (Ag), powder characteristics of the NiCuZn ferrite material or other additives are being developed.

Meanwhile, since silver (Ag) as the internal electrode, which is a noble metal, is not oxidized at a high temperature, de-binding (a process of removing organic substance on the semi-finished product at a high temperature) and sintering process may be performed in a general ambient atmosphere.

Meanwhile, silver (Ag) used as the internal electrode, which is a metal having the lowest resistivity, has many advantages. However, silver (Ag) is expensive since it is a noble metal, and temporal price variation thereof is large. Further, silver (Ag) is used as a solar cell electrode material and thus a lot of demand for silver (Ag) is expected in the future, and a recent sudden rise in silver (Ag) prices imposes a heavy burden on product costs.

Therefore, metals, which are cheap and have electrical conductivity similar to silver (Ag), are investigated. Among them, copper (Cu) has a higher resistivity than silver (Ag) by about 6% in a pure state. That is, copper (Cu) has a resistivity almost similar to that of silver (Ag). Thus, it was determined that copper (Cu) can substitute for silver (Ag). Therefore, a NiZn ferrite composition was developed, invented, and filed as a ferrite material, instead of the conventional NiCuZn ferrite.

Meanwhile, a rough process of forming a coil in a multilayer coil element is shown in FIG. 1. The multilayer coil element is manufactured by punching a via hole 20 for interlayer connection in a ceramic sheet 10 including organic substance, which is prepared through tape casting, and printing a silver internal conductor paste 30 on the sheet through the via hole 20 commonly using screen printing to form a pattern.

The printed patterns are laminated in the exact position, and a coil is entirely formed by connection of the silver paste through the interlayer via. The coil type semi-finished product is cut into individual chips, and hot air is applied in the atmosphere to remove the organic substance (de-binding). The resultant product is fired in a furnace at a high temperature of more than 800° C. to form a chip inductor.

Meanwhile, in order to use copper as an internal conductor, sintering in a reducing atmosphere with less oxygen is needed to prevent oxidization of copper. However, in this case, since the NiCuZn ferrite, which is a general material of the multilayer coil element, has poor resistance to reduction and thus reduction of the material causes destruction of a structure, deterioration of magnetic characteristics, and prevention of densification by sintering. Therefore, up to now, an Ag internal electrode has been used in all multilayer inductors.

### RELATED ART DOCUMENT

### Patent Document

Patent Document 1: Japanese Patent Laid-open No. 2000-233967

### SUMMARY OF THE INVENTION

In manufacture of a general multilayer coil type product, internal electrode coil patterns printed on green sheets of a ferrite body are aligned according to the order and laminated and formed into one body by high temperature compression. Then, the laminate is separated into individual product chips, and the chips are sintered again at a high temperature.

A de-binding process is performed before sintering to remove the excessively added organic substance. At this time, in the prior art in which Ag is used as an internal electrode coil pattern, there is no problem since oxidization doesn't occur in a high temperature ambient atmosphere.

However, when using Cu as an internal electrode coil pattern, an oxidation speed is increased when exceeding only 150° C. Thus, in the ambient atmosphere sintering, Cu particles are all oxidized in the de-binding step and all dissolved later during sintering to exist as oxides, and some of them are absorbed into the ceramic body. Therefore, when using Cu as an internal electrode coil pattern, the ceramic body should be sintered in a thin oxygen condition in which Cu isn't oxidized.

However, in the conventional NiCuZn ferrite, when oxygen partial pressure is reduced to less than 0.01 atm, CuO, which is an internal component, is deposited so that the valence of Fe ions is changed to have conductivity. At this time, unlike a winding type product in which an internal electrode coil conductor is coated with enamel to insulate between a ceramic body and an electrode, in the multilayer type product, the electrode is embedded in the ceramic body.

Therefore, since the ceramic body and the internal electrode coil conductor are in direct contact with each other, electricity flows parallel in the ceramic body 110 as in FIG. 2(b) as well as in the metal internal electrode coil conductor 130 as in a normal chip of FIG. 2(a). Thus, current flowing in the coil is reduced and desired characteristics can't be obtained (arrow: direction of flow of current).

Therefore, the applicant of the present invention filed an application for a patent on a low temperature sintered NiZn ferrite composition which exhibits equivalent characteristics while removing copper (Cu) from a ceramic body composition.

However, in case of the NiZn ferrite composition, in a thin oxygen atmosphere, as in the following equation 1, NiO and ZnO are deposited, and the amount of an iron oxide in the remaining components is increased to more than 50 mol %.

$${ZnFe}_{2} {O}_{4} -> 3 m Zn O + ( 1 - m ) {Zn}_{X} {Fe}_{3 - X} {O}_{4} + m / 2 {O}_{2} \\ {NiFe}_{2} {O}_{4} -> 3 m NiO + ( 1 - m ) {Ni}_{X} {Fe}_{3 - X} {O}_{4} + m / 2 {O}_{2} \\ ( X = \frac{1 - 3 m}{1 - m} ) \qquad ( Equation 1 )$$

When the amount of the iron oxide in the remaining ferrite components is increased to more than 50 mol % in terms of Fe₂O₃, Fe²⁺ ions are generated. In this case, Fe²⁺ ions exchanges electrons with peripheral 3+ ions as in the following equation 2 to generate conductivity. This is known as an electron hopping mechanism.

Fe³⁺+e⁻ [symbol] Fe²⁺ (Equation 2)

Therefore, in the conventional material, very precise step-by-step process control of oxygen partial pressure and pressure in a sintering profile was needed, and additional reoxidation annealing was actually needed.

Accordingly, the present invention conducted additional improvement to increase a sintering process window with actually low manufacturing costs and improve insulation characteristics of a material.

Therefore, it is an object of the present invention to provide a coil element that can improve characteristics of a coil type product made of the conventionally developed material.

Further, it is another object of the present invention to provide a ferrite material that can be used as a ceramic body of a coil element.

Additionally, it is another object of the present invention to provide a method for manufacturing a coil element.

In accordance with one aspect of the present invention to achieve the object, there is provided a coil element including a ceramic body and an internal electrode coil pattern formed on the ceramic body, wherein the ceramic body includes NiZnMn ferrite and the internal electrode coil pattern uses copper.

The NiZnMn ferrite may include Fe ions at a ratio of 0.53 to 0.67 and Mn ions at a ratio of 0.11 to 0.17 with respect to the total sum of Ni, Zn, Mn, and Fe ions.

The NiZnMn ferrite may include the Ni ions at a ratio of 0.01 to 0.154 with respect to the total sum of the Ni, Zn, Mn, and Fe ions.

It is preferred that a specific surface area of the NiZnMn ferrite in a powder state is 5 to 12 m²/g.

The ceramic body may further include a sintering additive.

The sintering additive may include glass and selectively include a metal oxide.

The coil element may be selected from multilayer type and winding type.

It is preferred that a resistivity of the coil element is greater than 1000 Ωcm.

Further, in accordance with another aspect of the present invention to achieve the object, there is provided NiZnMn ferrite including Fe ions at a ratio of 0.53 to 0.67 and Mn ions at a ratio of 0.11 to 0.17 with respect to the total sum of Ni, Zn, Mn, and Fe ions.

The Ni ions may be included at a ratio of 0.01 to 0.154 with respect to the total sum of the Ni, Zn, Mn, and Fe ions.

The NiZnMn ferrite may be used as a ceramic body of a coil element.

In accordance with still another aspect of the present invention to achieve the object, there is provided a method for manufacturing a coil element, including the steps of: manufacturing a ceramic green sheet; forming an internal electrode coil pattern on the ceramic green sheet; laminating the ceramic green sheets on which the coil pattern is formed; de-binding the laminated laminate by separating the laminated laminate into chips; and sintering the chip.

It is preferred that the ceramic green sheet uses NiZnMn ferrite.

The NiZnMn ferrite may include Fe ions at a ratio of 0.53 to 0.67 and Mn ions at a ratio of 0.11 to 0.17 with respect to the total sum of Ni, Zn, Mn, and Fe ions.

The NiZnMn ferrite may include the Ni ions at a ratio of 0.01 to 0.154 with respect to the total sum of the Ni, Zn, Mn, and Fe ions.

It is preferred that the internal electrode coil pattern uses copper.

The sintering may be performed in a thin oxygen condition in which oxygen partial pressure is 1 to 100 ppm.

The sintering may be performed at a temperature of 850 to 1050° C.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing coil formation of a chip inductor;

FIGS. 2a and 2b are views comparing the flow of current when a normal chip and a ceramic body are conductive, respectively;

FIGS. 3 to 5 are graphs showing the measurement results of density, internal permeability, and resistivity, respectively;

FIG. 6 is a graph showing the measurement results of impedance of a chip including an Ag internal electrode coil pattern in accordance with a comparative example;

FIG. 7 is a graph showing the measurement results of impedance of a ferrite bead using a Cu internal electrode coil pattern of the present invention, wherein a broken line indicates a mass production characteristic comparative value;

FIG. 8 is a graph showing the measurement results of saturation magnetization and coercivity characteristics according to the content of Fe of a coil element using NiZnMn ferrite of the present invention; and

FIG. 9 is a graph showing the measurement results of saturation magnetization and coercivity characteristics according to the content of Mn of the coil element using the NiZnMn ferrite of the present invention.

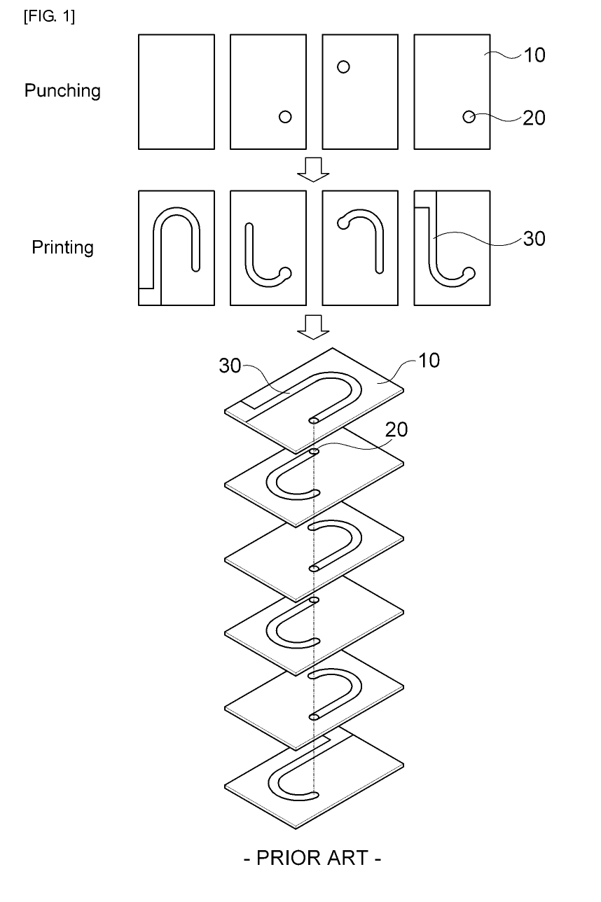

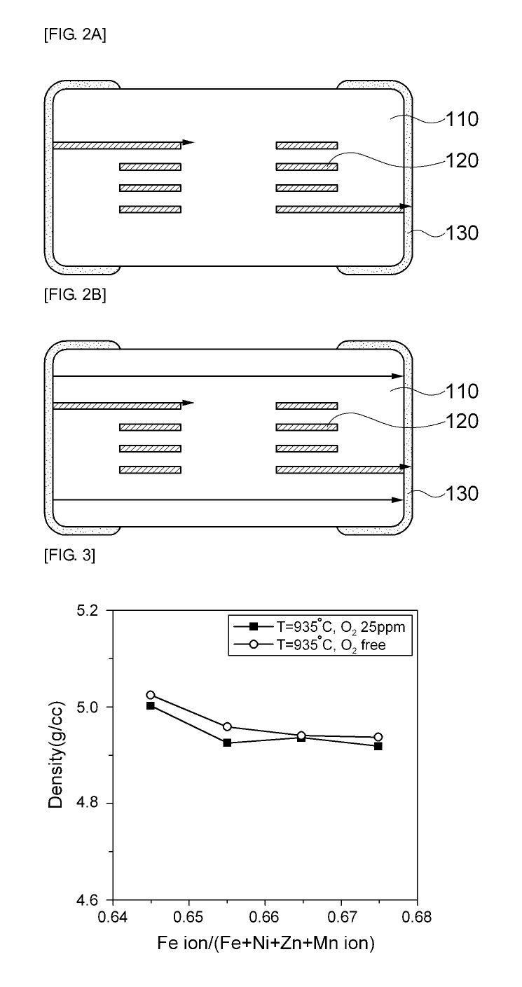

### DETAILED DESCRIPTION OF THE PREFERABLE EMBODIMENTS

Hereinafter, the present invention will be described in detail.

Terms used herein are provided to explain specific embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention can greatly increase a sintering process window and implement characteristics of a material through a single sintering process by suppressing conductivity due to generation of deposits inside the NiZn ferrite material in a thin oxygen atmosphere through addition of Mn to the conventional NiZn ferrite composition to increase a resistivity of the material.

A coil element in accordance with the present invention includes a ceramic body and an internal electrode coil pattern formed on the ceramic body, wherein the ceramic body includes NiZnMn ferrite, and the internal electrode coil pattern uses copper.

The ceramic body in accordance with the present invention uses the NiZnMn ferrite, and the NiZnMn ferrite mainly includes Ni, Zn, Mn, and Fe ions and small amounts of other components.

It is preferred that a ratio of the Fe ions to the total sum of the Ni, Zn, Mn, and Fe ions in the NiZnMn ferrite is in the range of 0.53 to 0.67.

The content of the Fe ions, which are included as a main component of the NiZnMn ferrite constituting the ceramic body, is in the range of 0.53 to 0.67 based on the total sum of the Ni, Zn, Mn, and Fe ions. When exceeding the above range, it is not possible to maintain a crystal structure, and a composition, which can't participate in the reaction, is generated according to the sintering atmosphere.

That is, when the content of the Fe ions is too low, that is, less than 0.53 as a ratio to the total sum of the entire ions, the composition can't participate in the reaction since the amount of NiO and ZnO is excessive from synthesis of the material. On the contrary, when the content of the Fe ions is too high, that is, greater than 0.67 as a ratio to the total sum of the entire ions, sintering properties of the material are deteriorated, and Fe²⁺ ions are generated and thus electrical conductivity is increased.

As a result of experiments, although a resistivity of the material may be increased when the Mn ions enter a position of Fe of the crystal structure, when the amount of the Fe ions exceeds 0.67, it is not possible to increase the resistivity of the material even by the addition of Mn. Further, on the contrary, when the content of the Fe ions is reduced to less than 0.53, there is an advantage that the resistivity of the material is increased, but there is a disadvantage that it is not possible to obtain a desired permeability range due to weak magnetism. Therefore, as a result, it is possible to maintain a resistivity at a level applicable to multilayer products while having high magnetic characteristics by preventing dissolution of the material in a thin oxygen atmosphere when the ratio of the Fe ions to the total sum of the entire ions is in the range of 0.53 to 0.67.

Further, in the NiZnMn ferrite constituting the ceramic body, the Mn ions are used to increase a resistivity, and it is preferred that a ratio of the Mn ions to the total sum of the Ni, Zn, Mn, and Fe ions is in the range of 0.11 to 0.17.

Although different according to the structure, in case of a multilayer inductor, since it is possible to satisfy the minimum characteristics when a resistivity is at least greater than 1000 Ωcm, the ratio of the Mn ions should be greater than 0.11 to stably secure a resistivity of greater than 1000 0cm. However, when the content of the Mn ions exceeds 0.17, while there is no big improvement in resistivity, there is a reduction in density.

Further, the nickel (Ni) ions are included for changes in permeability and saturation magnetization values of the NiZnMn ferrite, and a ratio of the Ni ions to the total sum of the Ni, Zn, Mn, and Fe ions may be in the range of 0.01 to 0.154.

The more the amount of Ni in the NiZnMn ferrite, the lower the permeability. Thus, the content of Ni may be minimum to obtain the maximum permeability, and in order to obtain the minimum permeability, the remainder except the minimum values of Fe and Mn may be the Ni ions.

Therefore, in the NiZnMn ferrite of the present invention, the ratio of the Ni ions to the total sum of the Ni, Zn, Mn, and Fe ions may be in the range of 0.01 to 0.154, and the content of the Ni ions may be selectively adjusted according to the desired level of permeability.

Further, the NiZnMn ferrite may include the remaining amount of the Zn ions except the Fe, Ni, and Mn ions. The Zn ions are added to adjust the initial permeability and the saturation magnetization.

Since the NiZnMn ferrite in accordance with the present invention has higher saturation magnetization than the conventional NiCuMn ferrite, it is suitable as a power inductor material due to advantages such as high permeability and high DC bias characteristics.

It is preferred that a specific surface area of the NiZnMn ferrite in accordance with the present invention is 5 to 12 m²/g in a powder state in terms of progress of a process and implementation of the appropriate sintering properties of the material.

Further, the ceramic body in accordance with the present invention may further include a sintering additive to improve the sintering properties of the NiZnMn ferrite.

The sintering additive may include glass, and metal oxides such as Bi₂O₃ and glass frit may be selectively mixed. It is preferred that the sintering additive is included in the NiZnMn ferrite by up to 5 wt %.

The coil element in accordance with the present invention having the above composition has a resistivity of greater than 1000 Om, a permeability of greater than 50, and a density of greater than 4.8 g/cc.

Meanwhile, the coil element in accordance with the present invention may be manufactured by the steps of manufacturing a ceramic green sheet, forming an internal electrode coil pattern on the ceramic green sheet, laminating the ceramic green sheet on which the coil pattern is formed, de-binding laminated laminate by separating the laminated laminate into chips, and sintering the chip.

It is preferred that the ceramic green sheet uses NiZnMn ferrite, and it is preferred that a ratio of Fe ions to the total sum of Ni, Zn, Mn, and Fe ions is 0.53 to 0.67 and a ratio of the Mn ions to the total sum of the Ni, Zn, Mn, and Fe ions is 0.11 to 0.17 in the NiZnMn ferrite.

Further, the NiZnMn ferrite may include the Ni ions at a ratio of 0.01 to 0.154 with respect to the total sum of the Ni, Zn, Mn, and Fe ions and the remaining amount of the Zn ions.

In the present invention, the green sheet is manufactured, and via holes are formed in the green sheet for interlayer connection. Next, the internal electrode coil pattern is formed by printing an internal conductor paste on the green sheet, which is a ceramic body, through the via hole using common screen printing.

The internal electrode coil pattern in accordance with the present invention is characterized by being formed of copper (Cu). In order to use copper as the internal electrode coil pattern, sintering in a reducing atmosphere with less oxygen is needed to prevent oxidation of copper. However, since the NiCuZn ferrite, which is a ceramic body material of the conventional coil element, has poor resistance to reduction, reduction of the material causes destruction of a structure, deterioration of magnetic characteristics, and prevention of densification by sintering.

Accordingly, the present invention can overcome problems occurring in using copper as an internal electrode coil pattern by using the above NiZnMn ferrite as the ceramic body material.

Further, the coil element in accordance with the present invention forms the laminate by aligning the internal electrode coil patterns printed on the green sheets according to the order, stacking the green sheets, and laminating the green sheets through high temperature compression. Next, the coil element in accordance with the present invention can be manufactured by passing through the steps of de-binding the laminate by separating the laminate into individual product chips and sintering the chips.

The NiZnMn ferrite in accordance with the present invention is characterized in that its structure isn't destroyed even in a thin oxygen condition in which oxygen partial pressure is 1 to 100 ppm and its magnetic characteristics aren't deteriorated.

It is preferred that the sintering is performed at a temperature of 850 to 1050° C.

The coil element in accordance with the present invention may be used in one selected from multilayer type and winding type.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### EMBODIMENT

### Checking of Characteristics of Ferrite according to Content of Each ion

NiZnMn ferrite having an ion composition ratio as in the following Table 1 is prepared. Characteristics (density, resistivity, permeability) of a sintered material using the NiZnMn ferrite according to each composition are evaluated. The ferrite prepared by the following composition is sintered at a sintering temperature of 940° C., and glass 1 wt % is added as a sintering additive.

Particularly, since there are several Mn oxides, the amount of Mn is shown in terms of the cation content of Mn₂O₃for convenience.

TABLE 1

| | | | | | Specific | | | |
|---|---|---|---|---|---|---|---|---|
| | | | | | surface | | | |
| | | | | | area of | Characteristics of sintered | | |
| | | | | | NiZnMn | material | | |
| | Ratio of each ion in NiZnMn ferrite⁽¹⁾ | | | | ferrite | Density | Resistivity | |
| | Fe | Ni | Zn | Mn | (m²/g) | [g/cc] | [Ωcm] | Permeability |
| *1 | 0.645 | 0.103 | 0.187 | 0.065 | 8.47 | 5.06 | 23 | 133.5 |
| *2 | 0.654 | 0.103 | 0.179 | 0.064 | 8.79 | 5.04 | 21 | 151.6 |
| *3 | 0.662 | 0.102 | 0.172 | 0.064 | 8.53 | 5.04 | 7 | 153.5 |
| *4 | 0.671 | 0.101 | 0.165 | 0.063 | 8.15 | 5.1 | 15 | 208.1 |
| *5 | 0.696 | 0.075 | 0.168 | 0.062 | 8.28 | 5.01 | 73 | 327.5 |
| *6 | 0.712 | 0.061 | 0.166 | 0.061 | 7.94 | 4.94 | 65 | 289.7 |
| *7 | 0.691 | 0.074 | 0.16 | 0.074 | 7.56 | 4.95 | 51 | 296.9 |
| *8 | 0.687 | 0.074 | 0.153 | 0.086 | 7.95 | 4.92 | 36 | 260.8 |
| *9 | 0.683 | 0.073 | 0.146 | 0.098 | 7.85 | 4.97 | 72 | 311.6 |
| *10 | 0.679 | 0.073 | 0.139 | 0.109 | 7.91 | 4.93 | 31 | 263.5 |
| 11 | 0.646 | 0.075 | 0.168 | 0.112 | 7.95 | 5 | 3696 | 315.9 |
| 12 | 0.654 | 0.074 | 0.16 | 0.111 | 8.06 | 4.93 | 2025 | 282.4 |
| 13 | 0.663 | 0.074 | 0.153 | 0.11 | 8.07 | 4.94 | 1448 | 285.3 |
| *14 | 0.671 | 0.073 | 0.146 | 0.11 | 8.79 | 4.92 | 484 | 222.1 |
| 15 | 0.611 | 0.076 | 0.197 | 0.115 | 7.91 | 5.06 | 4833 | 177.1 |
| 16 | 0.62 | 0.076 | 0.19 | 0.114 | 8.2 | 5.04 | 2423 | 219.8 |
| 17 | 0.629 | 0.075 | 0.182 | 0.113 | 8.57 | 5.05 | 4289 | 262.6 |
| 18 | 0.638 | 0.075 | 0.175 | 0.113 | 8.18 | 5.03 | 1529 | 288.2 |
| 19 | 0.615 | 0.071 | 0.16 | 0.154 | 8.07 | 5.06 | 12477 | 144.5 |
| 20 | 0.627 | 0.071 | 0.16 | 0.142 | 8.11 | 5.03 | 7628 | 172.2 |
| 21 | 0.639 | 0.071 | 0.16 | 0.13 | 8.23 | 5.01 | 4244 | 210.7 |
| 22 | 0.651 | 0.071 | 0.16 | 0.118 | 7.83 | 4.97 | 2284 | 220.4 |
| 23 | 0.642 | 0.074 | 0.16 | 0.123 | 8.28 | 5.06 | 4000 | 350.1 |
| 24 | 0.638 | 0.074 | 0.153 | 0.135 | 8.45 | 5.04 | 8022 | 319.6 |
| 25 | 0.634 | 0.073 | 0.146 | 0.146 | 8.65 | 5.04 | 6529 | 310.3 |
| 26 | 0.63 | 0.073 | 0.139 | 0.158 | 7.25 | 5.01 | 11351 | 294.5 |
| 27 | 0.628 | 0.075 | 0.139 | 0.157 | 8.71 | 5.09 | 2102 | 274.88 |
| 28 | 0.628 | 0.068 | 0.139 | 0.164 | 8.65 | 5.1 | 6670 | 364.58 |
| *29 | 0.628 | 0.061 | 0.139 | 0.171 | 8.36 | 4.71 | 1612 | 193.06 |
| *30 | 0.628 | 0.055 | 0.139 | 0.178 | 8.57 | 4.64 | 6180 | 169.7 |
| 31 | 0.628 | 0.068 | 0.139 | 0.164 | 7.68 | 4.94 | 2327 | 288.44 |
| *32 | 0.521 | 0.165 | 0.193 | 0.121 | 8.11 | 5.04 | 5024362 | 44.2 |
| *33 | 0.527 | 0.172 | 0.181 | 0.12 | 8.35 | 5.09 | 7028364 | 48.3 |
| 34 | 0.537 | 0.154 | 0.188 | 0.121 | 8.32 | 5.12 | 4083227 | 89.6 |
| 35 | 0.547 | 0.153 | 0.18 | 0.12 | 8.17 | 5.03 | 8048671 | 88.3 |
| 36 | 0.556 | 0.152 | 0.172 | 0.119 | 8.23 | 5.07 | 831018 | 88 |
| 37 | 0.566 | 0.151 | 0.164 | 0.118 | 8.18 | 5.15 | 816527 | 104.8 |
| 38 | 0.575 | 0.15 | 0.157 | 0.118 | 8.48 | 5.07 | 1093288 | 107.7 |
| 39 | 0.584 | 0.149 | 0.149 | 0.117 | 8.19 | 5.05 | 232138 | 99.6 |
| 40 | 0.594 | 0.148 | 0.142 | 0.116 | 8.06 | 5.04 | 298854 | 93.2 |
| 41 | 0.603 | 0.147 | 0.135 | 0.115 | 7.95 | 5.04 | 65658 | 101.1 |
| *42 | 0.622 | 0.135 | 0.216 | 0.027 | 7.76 | 5.01 | 710 | 103.7 |
| *43 | 0.631 | 0.134 | 0.208 | 0.027 | 7.35 | 4.91 | 645 | 92.6 |
| *44 | 0.64 | 0.133 | 0.2 | 0.027 | 7.28 | 4.98 | 696 | 109.9 |
| *45 | 0.649 | 0.132 | 0.192 | 0.026 | 7.51 | 4.81 | 280 | 103 |
| *46 | 0.64 | 0.133 | 0.2 | 0.027 | 8.72 | 5.16 | 525 | 156.1 |
| *47 | 0.658 | 0.118 | 0.198 | 0.026 | 8.25 | 5.12 | 482 | 240.7 |
| *48 | 0.675 | 0.104 | 0.195 | 0.026 | 8.23 | 5.11 | 189 | 278 |
| *49 | 0.692 | 0.09 | 0.192 | 0.026 | 8.06 | 5.03 | 49 | 214.2 |

*Examples outside the range of the present invention.
⁽¹⁾The ratios of the respective Ni, Zn, Mn, and Fe ions represent the ratios of the respective ions when the total sum of the Ni, Zn, Mn, and Fe ions is 1.

Referring to the results of the above Table 1, the more the amount of Fe ions, the higher the permeability, but on the other hand, the resistivity of the material is reduced. In a multilayer inductor requiring a resistivity of at least greater than 1000 Ωcm, it is needed to limit the amount of the Fe ions to less than 0.67.

However, when the amount of the Fe ions is reduced, the resistivity is increased but the permeability and magnetic characteristics are deteriorated. Therefore, although the characteristics of the material are deteriorated, it is preferred to add the FE ions in an amount of greater than 0.53 since the Fe ions can be used according to each purpose.

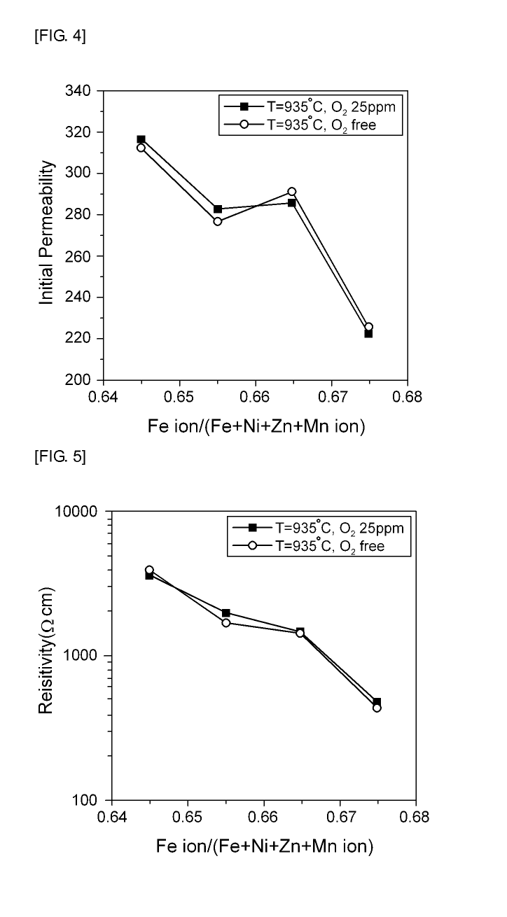

The characteristics (density, permeability, resistivity) of the sintered material according to the content of the Fe ions are shown in the following FIGS. 3 to 5, respectively.

Further, the addition of Mn ions increases the resistivity. As a result of experiments, it is checked that the Mn ions should be added in an amount of greater than 0.11 to stably secure a resistivity of 1000 Ωcm. However, when the content of the Mn ions exceeds 0.17, the resistivity is not improved anymore, and the density is reduced to less than 4.8 g/cc.

Therefore, it is possible to obtain a wide range of composition according to the contents of Ni and Zn based on the ratios of the Fe and Mn ions measured in the above embodiment. Thus, it is possible to develop a material having a wide range of characteristics that can complement the characteristics of most of the currently mass-produced NiCuZn ferrite by adjusting the relative ratios of NiO and ZnO while maintaining the composition ratios of Fe and Mn in the range of having both of conductivity and material characteristics.

### EMBODIMENT

### Manufacture of Coil Element

A coil element (bead), which uses the NiZnMn ferrite in accordance with the present invention of the above Table 1 as a ceramic body and includes an internal electrode coil pattern using copper on the ceramic body, is manufactured.

### COMPARATIVE EXAMPLE

A coil element (bead), which uses the mass-produced NiZnCu ferrite as a ceramic body and includes an internal electrode coil pattern using silver (Ag) on the ceramic body, is manufactured.

### EXPERIMENTAL EXAMPLE

### Evaluation of Characteristics of Coil Element

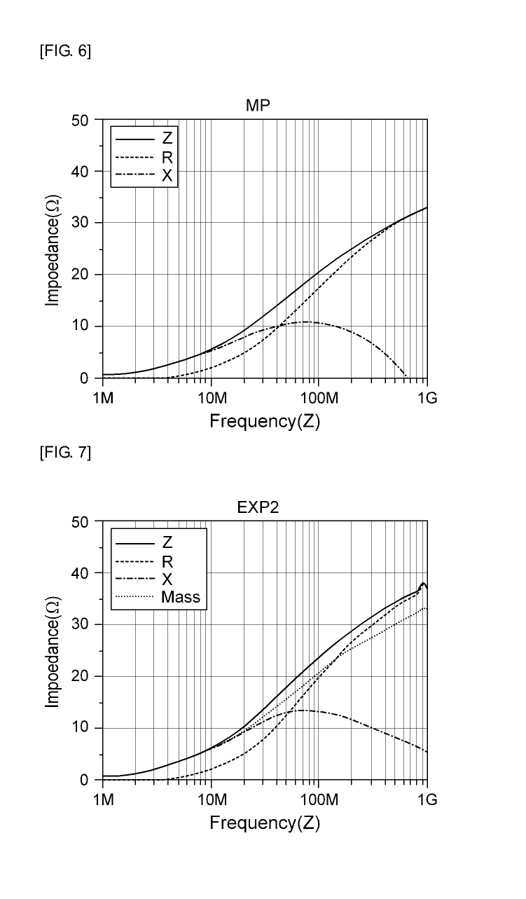

Impedance characteristics of the coil elements (ferrite beads) manufactured in the above embodiment and comparative example are evaluated, and the results thereof are shown in the following FIGS. 6 and 7, respectively.

FIG. 6 shows the measurement results of impedance of the conventional coil element including silver (Ag) as an internal electrode coil pattern. By comparison, referring to FIG. 7 in accordance with the present invention, the results show that the conductivity of the ferrite is remarkably suppressed by the addition of the appropriate amount of Mn as a ceramic body and the appropriate total amount of Fe and Mn.

Therefore, as a result, ferrite, which can implement mass-production characteristics and apply a Cu internal electrode having a high sintering widow, is developed using the present developed material. Thus, it is possible to reduce material costs of the internal electrode to less than 1/10 by implementing the characteristics of the material without using Ag.

### EXPERIMENTAL EXAMPLE

### Evaluation of Characteristics of Coil Element

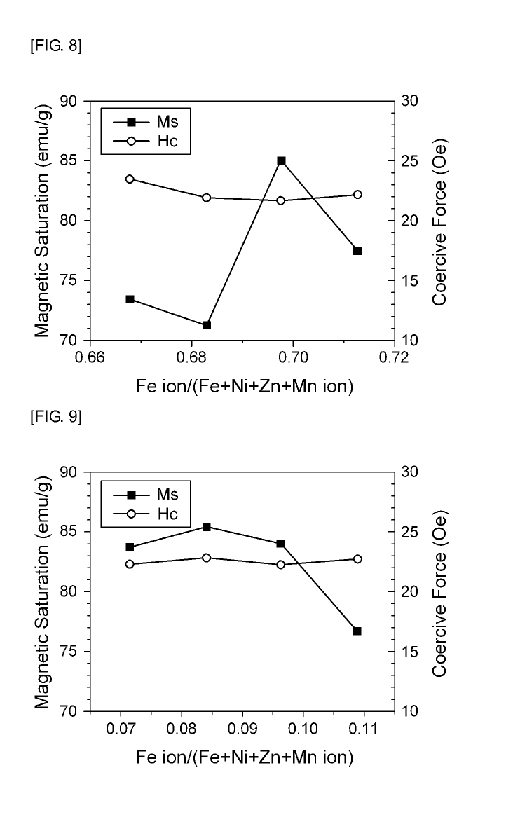

Saturation magnetization and coercivity characteristics of the coil element (bead) using the NiZnMn ferrite of the present invention according to the contents of Fe ions and Mn ions are evaluated, and the results thereof are shown in the following FIGS. 8 and 9, respectively.

Referring to FIGS. 8 and 9, while a maximum value of the saturation magnetization of the mass-produced NiCuZn ferrite is 70 emu/g, the NiZnMn ferrite in accordance with the present invention reaches 85 emu/g. Thus, it is checked that DC bias characteristics are improved by about 20%.

Therefore, since the NiZnMn ferrite material in accordance with the present invention has both of high permeability and saturation magnetization values, it is particularly suitable for use in a power inductor.

The NiZnMn ferrite in accordance with the present invention can greatly increase a sintering process window and implement characteristics of a material through a single sintering process by suppressing conductivity due to generation of deposits inside the NiZn ferrite material in a thin oxygen atmosphere through addition of Mn to the conventional NiZn ferrite composition to increase a resistivity of the material.

Further, since the NiZnMn ferrite in accordance with the present invention has higher saturation magnetization than the conventional NiCuZn ferrite, it can be usefully used as a ceramic body of a coil element due to advantages such as high permeability and DC bias characteristics.

Further, the coil element in accordance with the present invention can improve insulation characteristics of a material with low manufacturing costs by including NiZnMn ferrite as a ceramic body and copper as an internal electrode coil pattern.

What is claimed is:

1. A coil element comprising:
a ceramic body; and
an internal electrode coil pattern formed on the ceramic body, wherein the ceramic body comprises NiZnMn ferrite, and the internal electrode coil pattern uses copper.

2. The coil element according to claim 1, wherein the NiZnMn ferrite comprises iron (Fe) ions at a ratio of 0.53 to 0.67 and manganese (Mn) ions at a ratio of 0.11 to 0.17 with respect to the total sum of Ni, Zn, Mn, and Fe ions.

3. The coil element according to claim 2, wherein the NiZnMn ferrite comprises the nickel (Ni) ions at a ratio of 0.01 to 0.154 with respect to the total sum of the Ni, Zn, Mn, and Fe ions.

4. The coil element according to claim 2, wherein a specific surface area of the NiZnMn ferrite in a powder state is 5 to 12 m²/g.

5. The coil element according to claim 1, wherein the ceramic body further comprises a sintering additive.

6. The coil element according to claim 5, wherein the sintering additive is selected from glass and a metal oxide.

7. The coil element according to claim 1, wherein the coil element is selected from multilayer type and winding type.

8. The coil element according to claim 2, wherein a resistivity of the coil element is greater than 1000 Ωcm.

9. A NiZnMn ferrite comprising Fe ions at a ratio of 0.53 to 0.67 and Mn ions at a ratio of 0.11 to 0.17 with respect to the total sum of Ni, Zn, Mn, and Fe ions.

10. The NiZnMn ferrite according to claim 9, wherein a ratio of the Ni ions is 0.01 to 0.154 with respect to the total sum of the Ni, Zn, Mn, and Fe ions.

11. The NiZnMn ferrite according to claim 9, wherein the NiZnMn ferrite is used as a ceramic body of a coil element.

12. A method for manufacturing a coil element, comprising:
manufacturing a ceramic green sheet;
forming an internal electrode coil pattern on the ceramic green sheet;
laminating the ceramic green sheets on which the coil pattern is formed;
de-binding the laminated laminate by separating the laminated laminate into chips; and
sintering the chip.

13. The method for manufacturing a coil element according to claim 12, wherein the ceramic green sheet uses NiZnMn ferrite.

14. The method for manufacturing a coil element according to claim 13, wherein the NiZnMn ferrite comprises Fe ions at a ratio of 0.53 to 0.67 and Mn ions at a ratio of 0.11 to 0.17 with respect to the total sum of Ni, Zn, Mn, and Fe ions.

15. The method for manufacturing a coil element according to claim 13, wherein the NiZnMn ferrite comprises the Ni ions at a ratio of 0.01 to 0.154 with respect to the total sum of the Ni, Zn, Mn, and Fe ions.

16. The method for manufacturing a coil element according to claim 12, wherein the internal electrode coil pattern uses copper.

17. The method for manufacturing a coil element according to claim 12, wherein the sintering is performed in an oxygen atmosphere in which oxygen partial pressure is 1 to 100 ppm.

18. The method for manufacturing a coil element according to claim 12, wherein the sintering is performed at a temperature of 850 to 1050° C.
